(19) United States
(12) Patent Application Publication
(10) Pub. No.: US 2005/0267925 A1
(43) Pub. Date: Dec. 1, 2005

(54) Methods and apparatus for transforming amplitude-frequency signal characteristics and interpolating analytical functions using circulant matrices

(76) Inventor: Vladimir I. Clue, Cambridge, MA (US)

Correspondence Address: Viadimir Clue, 429 Franklin Street, Unit 1L, Cambridge, MA, 02139, US

(21) Appl. No.: 10/856,453

(22) Filed: May 28, 2004

(51) Int. Cl. G06F 17/14

(52) U.S. Cl. 708/400

(57) ABSTRACT

A method of performing a direct discrete transformation of a signal includes reading amplitude-frequency characteristics of a signal from a sensor. The signal is associated with a base grid to form a digital representation of a function that has a discrete Fourier representation. A circulant matrix is calculated that represents a transformation of the signal on the base grid to a complex signal having real and imaginary parts representing the signal having transformed amplitude-frequency characteristics. The signal on the base grid is then transformed with the circulant matrix to obtain real and imaginary parts of the signal having transformed amplitude-frequency characteristics. The real and imaginary parts of the signal are then written to a display or a storage device.

The present invention is described with particularity in the below Detailed Description and claims Sections. The advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

### BRIEF DESCRIPTION OF THE DRAWINGS

FIG. 1 is a flow chart of a known method of transforming amplitude-frequency characteristics of digital signal data that includes performing both a direct Fourier transform and a reverse Fourier transform.

FIG. 2 is a flow chart of a method of directly transforming the amplitude-frequency characteristic of a signal using a circulant matrix according to the present invention.

FIGS. 3A-E show exemplary waveforms that illustrate the method that is described in connection with FIG. 2.

FIG. 4A is a flow chart of a method of directly interpolating application data with an analytical function according to the present invention.

FIGS. 4B and 4C illustrate transformations of the exemplary waveform signal of FIG. 3A using the method that is described in connection with FIG. 4A.

FIGS. 4D and 4E illustrate analytical function evaluation results obtained using the method that is described in connection with FIG. 4A.

FIG. 5A is a flow chart of a method of computing data using the ‘tilde’ operator according to the present invention.

FIG. 5B is a block diagram of a data acquisition and analysis system according to the present invention that can be used to acquire function values and analyze them to reinstate a function.

FIG. 5C is a graphical illustration of an exemplary wave function that is calculated from a probability density measurement according to the present invention.

FIG. 6 illustrates exemplary conformal mapping data obtained using the method that is described in connection with FIG. 5A.

FIGS. 7A-D illustrate exemplary harmonic ratio data that was obtained using a harmonic correlation method according to the present invention.

FIG. 7E shows exemplary functions having ratios that are equal to imaginary unit 1i.

FIGS. 8A-G illustrate market data for seven of 5000 companies in various industries that were analyzed using the method of harmonic correlation described herein.

FIG. 8H illustrates sorting results for the top five indexes using the prior art correlation method. FIG. 81 illustrates sorting results for the top five indexes using the harmonic correlation method of the present invention.

FIG. 9 is a block diagram of a data acquisition and analysis system according to the present invention that can be used to acquire and analyze financial data to identify companies having similar stock price behavior.

### DEFINITION SECTION

The following definitions are presented to clarify the meaning of terms used in the Detailed Description and claims Sections of the present application.

The term “frequency weights” is defined herein to mean a ratio for particular frequencies where the amplitude for a particular frequency signal is larger or smaller in the transformed signal in comparison to the original signal.

The term “phase shift” is defined herein to mean a change in the phase relationship between two alternating quantities.

The term “base grid” is defined herein to mean a grid having a unit radius (i.e. radius that is equal to one) and an initial argument that is equal to zero. The base grid can be represented as exp

$$( 2 i \cdot π \cdot \frac{n}{N} ) ,$$

where n ranges from 0-(N−1) and where n and N are integers. The base grid corresponds to the [0; 2π] interval known in the art.

The term “evaluation data” is defined herein to mean values that are calculated for particular requirements so as to represent the evaluated solution.

The term “evaluation grid” is defined herein to mean a grid where evaluation values are obtained. The evaluation grid is on a circle with a center (0,0), a starting point and radius that is inside a radius of convergence, and an argument that is between zero and 2π. The evaluation grid can be represented as

$$1 i \cdot ( ψ + j \cdot \frac{2 \cdot π}{N} )$$

where r is the radius and ψ is the argument of the starting point of the evaluation grid.

The term “continuation details” is defined herein to mean the behavior of the analytical function for which the interpolation results were obtained.

The term “eccentricity” is defined herein to mean the distance between the center of an eccentric and its axis.

The term “application data” is defined herein to mean data for a practical real world application. For example, application data can be financial data, such as stock market data that characterizes market conditions (i.e. stock prices and trading volumes). Application data can also be scientific data for practical mathematical physics problems, such as heat transfer, fluid dynamic, electrostatic, mechanical stress, and seismology problems.

The term “tilde” is defined herein as a mathematical operator having the following properties:

$$tilde ( u , v ) := \vert \begin{matrix}mu ← mean ( u ) \\ mv ← mean ( v ) \\ \frac{2}{N} \cdot ( ( u - mu ) \cdot ( v - mv ) + 1 i \cdot ( u - mu ) \cdot CircG ( v - mv ) )\end{matrix}$$

where CircG(v) is a function that returns the harmonic conjugate to the input vector data ‘v’. The term “CircG(v)” is herein defined as the unitary operator “˜” so that CircG(v)≡˜v. The term “tilde” is defined herein as the binary operator “˜” so that tilde(u,v)≡u˜v.

The term “harmonic equation” is defined herein to mean an equation where the relation of the arguments involves binary operator ‘˜’. Some examples are relations for complex function W(z), which is analytical inside unit circle. The real part of W(z) and its imaginary part on the base grid are connected by the following harmonic equation:
Im(W(α))=˜(Re(W(α))).
The argument and norm of W(z) on the base grid are connected by the following harmonic equation:
(φ(α)−α)=˜(0.5*Ln(norm(W(α)−W(0)))), where φ(α)—argument of (W(α)−W(0)),
where the derivative of W satisfies the following harmonic equation:
(ψ(α)−(α+π/2))=˜(0.5*Ln(norm(W(α)′))), where
ψ(α)—tangent angle to boundary curve in W(α).

### DETAILED DESCRIPTION

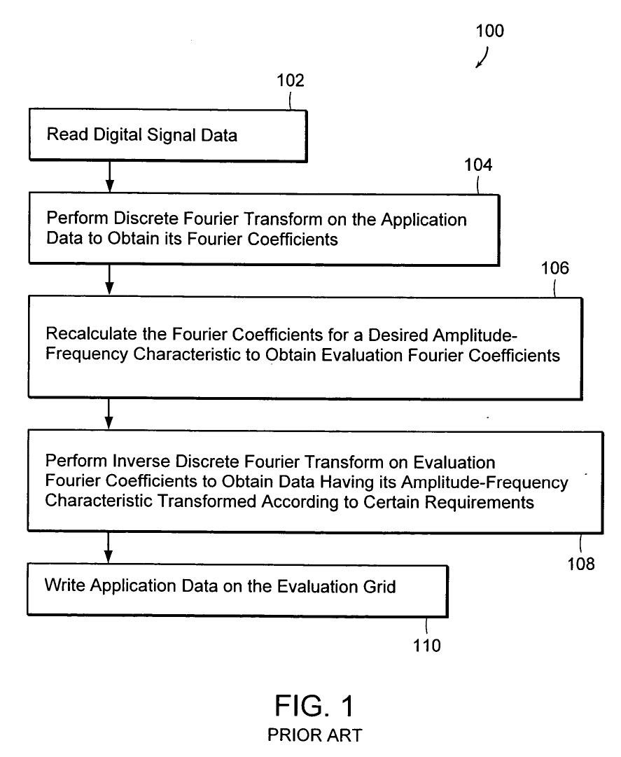

One aspect of the present invention relates generally to transforming the amplitude-frequency characteristics of a signal. Amplitude frequency characteristics are also known as Fourier representations. FIG. 1 is a flow chart of a known method 100 of transforming amplitude-frequency characteristics of digital signal data that includes performing both a direct Fourier transform and a reverse Fourier transform. The method 100 includes a step 102 of reading digital signal data. Step 102 can be preformed using a processor having an input device for reading application data. The application data can be any type of application data, such as financial data and scientific data.

Step 104 includes performing a Fourier transform on the application data in order to obtain its Fourier coefficients. Fourier transforms are well known and commonly used to analyze the frequencies content of waveforms. The method 100 is described in connection with a discrete Fourier transform (DFT). However, the method 100 can be applied to other types of Fourier transforms. Discrete Fourier transforms are linear, invertible functions that include a set of complex numbers. For digital signal processing applications, a DFT can be represented as follows:

$${a}_{k} := \frac{2}{N} \cdot {\sum }_{t = 0}^{N - 1} {u}_{t} \cdot cos ( 2 \cdot π \cdot \frac{k \cdot t}{N} )$$

$${b}_{k} := \frac{2}{N} \cdot {\sum }_{t = 0}^{N - 1} {u}_{t} \cdot sin ( 2 \cdot π \cdot \frac{k \cdot t}{N} ) j = 0 , … , n - 1.$$

The DFT transforms n complex numbers W₀, . . . , Wₙ₋₁ into Fourier coefficients cⱼ. This representation of the DFT is useful for interpolating analytical functions. The DFT can be represented as follows:

$${c}_{j} := \frac{1}{N} \cdot {\sum }_{t = 0}^{N - 1} {W}_{t} \cdot exp [ ( \frac{- 2 \cdot π \cdot 1 ⅈ}{N} ) \cdot t \cdot j ] .$$

Step 106 includes recalculating the Fourier coefficients cⱼ for a desired amplitude-frequency characteristic transformation to obtain evaluation Fourier coefficients. Recalculating Fourier coefficients is well known in the art. The recalculated Fourier coefficients can be represented by the following equation:
a_{—}newₖ:=[λₖ·μ^{k}·(aₖ·cos(k·ψ)+bₖ·sin(k·ψ))] b_{—}newₖ:=[λₖ·μ^{k}·(bₖ·cos(k·ψ)−aₖ·sin(k·ψ))].
Such a representation is useful for signal processing applications. Applications that require the interpolation of analytical functions can calculate the following Fourier coefficients:
C_{—}newⱼ:=Lam(λ,j)·R^{j}·cⱼ·exp(1i·ψ·j)
where R is functionally similar to μ in the previous expression, but also includes geometrical information related to the ratio of the evaluating grid radius to the base grid radius.

Step 108 includes performing an inverse discrete Fourier transform on the evaluation Fourier coefficients in order to obtain the desired data on the evaluation grid. The desired data has its amplitude-frequency characteristics transformed according to the desired requirements. Computing an inverse Fourier transform on Fourier coefficients is also well known in the art. The inverse Fourier transform can be represented by the following equation:

$${Ws\_new}_{j} := [ {\sum }_{k = 0}^{K} [ {a\_new}_{k} \cdot cos [ k \cdot ( {ω}_{j} ) ] + {b\_new}_{k} \cdot sin [ k \cdot ( {ω}_{j} ) ] ] ] + 1 i \cdot [ {\sum }_{k = 0}^{K} [ {( - b\_new )}_{k} \cdot cos [ k \cdot ( {ω}_{j} ) ] + {a\_new}_{k} \cdot sin [ k \cdot ( {ω}_{j} ) ]$$

The inverse DFT recovers the complex numbers Ws_new₀, . . . , Ws_newₙ₋₁ from the recalculated Fourier coefficient. This inverse Fourier transform is useful for signal processing applications. The inverse Fourier transform can be used for interpolating an analytical function in the following way:

$${Wf\_new}_{j} := {\sum }_{t = 0}^{N - 1} {C\_new}_{t} \cdot exp [ ( \frac{2 ⅈ \cdot π \cdot j}{N} ) \cdot t ] .$$

The inverse Fourier transform recovers the complex numbers Wf_new₀, . . . , Wf_newₙ₋₁ from the recalculated Fourier coefficients. Ws_new and Wf_new are equal to each other. The representations are different for different applications. For example, in digital sound processing applications, one might desire to use only the real part of the harmonic representation. Step 110 includes writing application data on the evaluation grid.

The prior art method 100 of transforming application data includes performing both a Fourier transform to obtain Fourier coefficients and additionally performing an inverse Fourier transform on the Fourier coefficients. Both the transform and the inverse transform are required to obtain a signal having transformed amplitude-frequency characteristics or interpolation values of an analytical function on the evaluation grid. Thus, the desired data is obtained in a two-step process that includes both a transform and an inverse transform. Obtaining the desired data using a two-step process that includes an inverse transform is more computational intensive and less accurate compared with the direct transform method of the present invention that is described in connection with the following figures.

In one aspect of the present invention, the methods and apparatus of the present invention use circulant matrices to perform discrete transforms of amplitude-frequency signal characteristics. Using circulant matrices according to the present invention is computationally efficient because the transforms and the interpolations can be performed without calculating the Fourier representation of the application data.

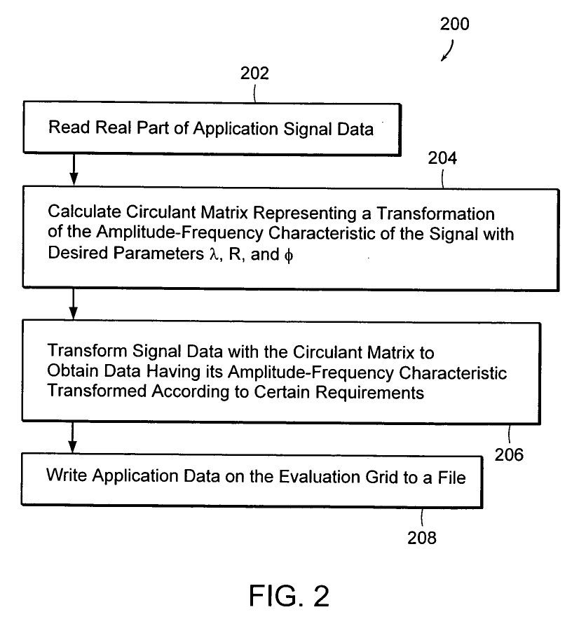

FIG. 2 is a flow chart of a method 200 of directly transforming the amplitude-frequency characteristic of a signal using a circulant matrix according to the present invention. The method 200 does not include calculating the signal's Fourier representation of the application data. The tasks of transforming the signal and interpolating the values of the analytical function on the evaluation grid are performed by using a single multiplication operation of a circulant matrix and a vector data. The vector data can be either digital signal data (such as a digital signal representation of measured sound, a digital representation of light or vibration analog signal data) or the real part of an analytical function presented by its values on the base grid.

The method 200 includes the step 202 of reading the real part of application signal data on a base grid. Step 204 includes calculating a circulant matrix representing a transformation of the amplitude-frequency characteristic of the signal with certain desired parameters. In one embodiment, the circulant matrix has predetermined frequency weights and predetermined phase shifts. Step 206 includes transforming the real part of the application data on the base grid with the circulant matrix in order to obtain the desired data. Step 208 includes writing the application data on the evaluation grid.

For example, in one embodiment, the method of computing the first row of the transformation circulant matrix is as follows:

$$ML ( N , λ , R , ψ , n ) := \vert \begin{matrix}ξ ← \frac{2 ⅈ \cdot π}{N} \cdot - n + 1 ⅈ \cdot ψ \\ K ← floor ( 0.5 \cdot ( N - 1 ) ) \\ if ξ = 0 \\ \vert \begin{matrix}\frac{2}{N} \cdot {\sum }_{t = 1}^{K} Lam ( λ , t ) if R = 1 \\ ( \frac{2}{N} \cdot {\sum }_{t = 1}^{K} Lam ( λ , t ) \cdot {R}^{t} ) otherwise\end{matrix} \\ \frac{2}{N} \cdot {\sum }_{t = 1}^{K} Lam ( λ , t ) \cdot {R}^{t} \cdot exp ( t \cdot ξ ) otherwise\end{matrix}$$

where the variable N is the number of points, the variable n is the number of element in the row, λ and R are frequency weights, and ry is the phase shift. For signal processing applications, the argument R is typically denoted as μ. The number of calculations necessary to obtain the desired values is proportional to N*K.

The method 200 is useful in applications that require processing many samples using the same circulant matrix (same N, λ, R and ψ) because of the high computational efficiency of the method. For many signal processing application, the desired result is achieved by simply multiplying an already known circulant matrix by the digital signal data. Thus, the method 200 can require much less computations to achieve the desired results compared with known methods.

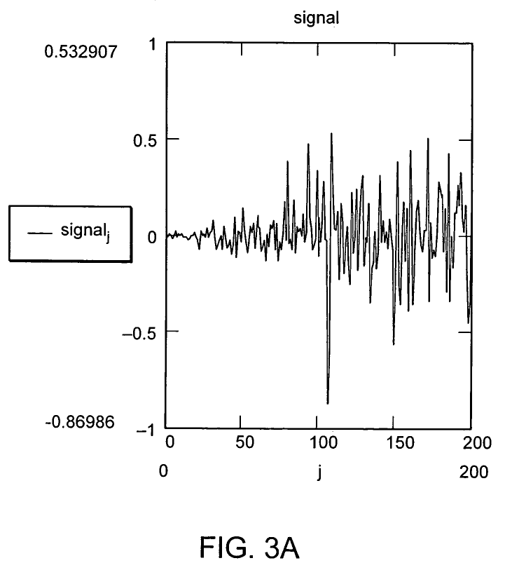

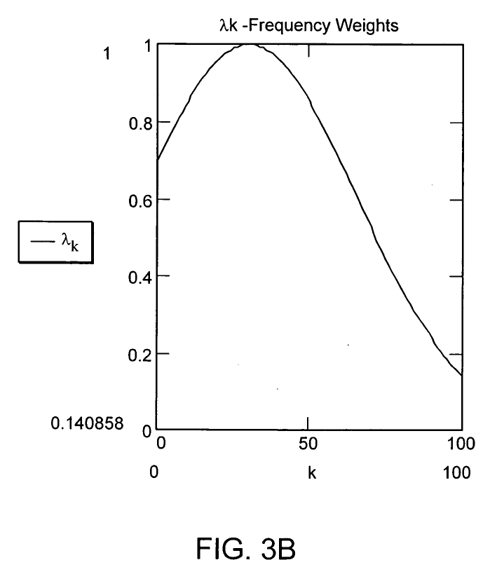

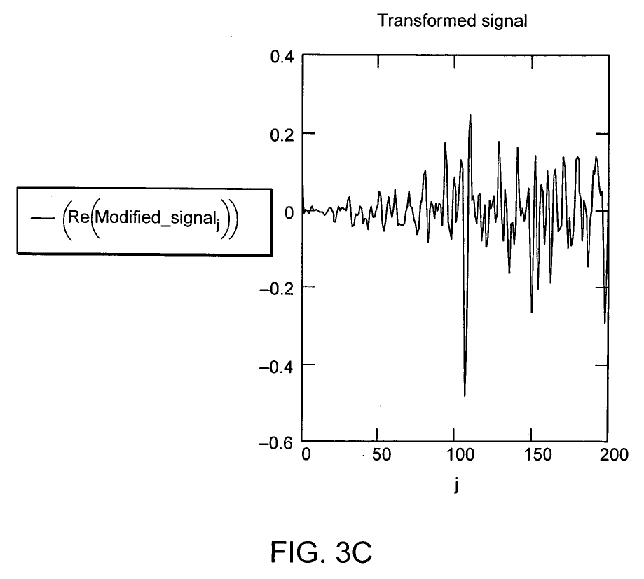

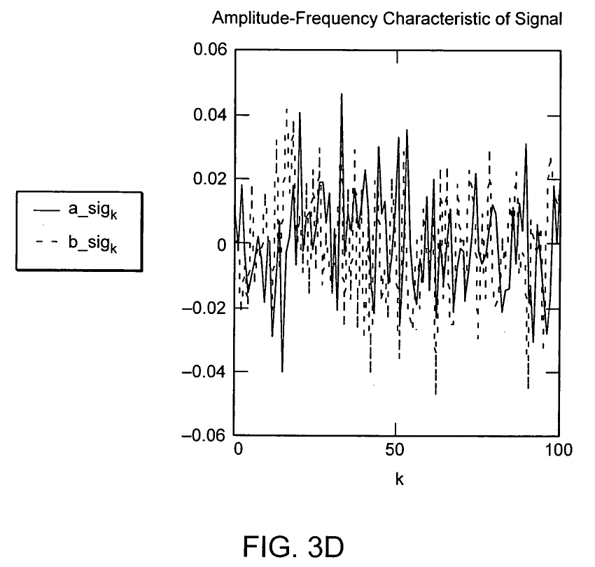

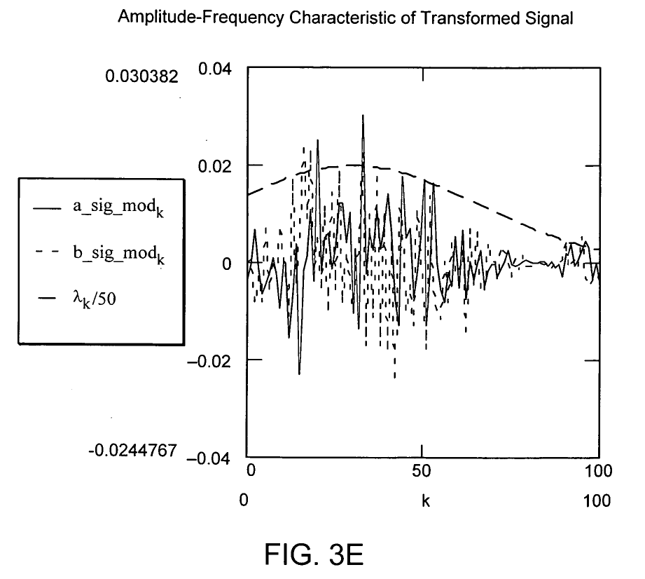

FIGS. 3A-D shows exemplary waveforms that illustrate the method 200 that is described in connection with FIG. 2. FIG. 3A shows the exemplary signal waveform. FIG. 3B shows the exemplary frequency weights λₖ for the exemplary signal waveform. The frequency weights λₖ in this example can be represented by the following equation:

$${λ}_{k} := {ⅇ}^{\frac{- {( 0.3 \cdot K - k )}^{2}}{{K}^{2}} \cdot 4} .$$

In the general case, λₖ are arbitrary numbers. Alternatively, frequency weights are defined as factors, by which the wavelengths get multiplied as the result of the transformation.

FIG. 3C shows the transformed exemplary signal waveform of FIG. 3A after it has been modified by the circulant matrix. The transformation was performed by the method Circλ(u, ML, λ, μ, ψ), which takes ‘u’ as an input signal and performs method ‘ML’ to generate the circulant matrix. The parameters of the transform for the method “ML” are ‘λ’, ‘μ’, and ‘ψ’. The method Circλ generates the circulant matrix row, and computes the multiplication of the generated circulant matrix-to-vector containing the input signal. Result of the circulant matrix-to-vector multiplication is the vector, containing the transformed signal.

The amplitude-frequency characteristic of the signal can be represented as follows:

$${a\_sig}_{k} := \frac{2}{N} \cdot {\sum }_{t = 0}^{N - 1} {signal}_{t} \cdot cos ( 2 \cdot π \cdot \frac{k \cdot t}{N} )$$

$${b\_sig}_{k} := \frac{2}{N} \cdot {\sum }_{t = 0}^{N - 1} {signal}_{t} \cdot sin ( 2 \cdot π \cdot \frac{k \cdot t}{N} ) .$$

The amplitude-frequency characteristic of the transformed signal can be represented as follows:

$$a\_sig {\_mod}_{k} := \frac{2}{N} \cdot {\sum }_{t = 0}^{N - 1} {Modified\_signal}_{t} \cdot cos ( 2 \cdot π \cdot \frac{k \cdot t}{N} )$$

$$b\_sig {\_mod}_{k} := \frac{2}{N} \cdot {\sum }_{t = 0}^{N - 1} {Modified\_signal}_{t} \cdot sin ( 2 \cdot π \cdot \frac{k \cdot t}{N} ) .$$

FIG. 3D shows the amplitude-frequency characteristic of the signal a_sigₖ and b_sigₖ. FIG. 3E shows the amplitude-frequency characteristic of the modified signal a_sig_modₖ and b_sig_modₖ. The amplitudes of the wavelengths presented in the signal were changed by the transformation according to the frequency weights. The amplitude-frequency characteristic in FIG. 3E is directly proportional to the frequency weights in FIG. 3B.

In one embodiment, all the frequency weights are equal to the same constant. In this embodiment, the first row of the transformation circulant matrix can be represented as follows:

$$MC ( N , R , ψ , n ) := \vert \begin{matrix}ξ ← \frac{2 ⅈ \cdot π}{N} \cdot - n + ⅈ \cdot ψ \\ K ← floor ( 0.5 \cdot ( N - 1 ) ) \\ if ξ = 0 \\ \vert \begin{matrix}\frac{2 \cdot K}{N} if R = 1 \\ ( \frac{2}{N} \cdot R \cdot \frac{1 - {R}^{K}}{1 - R} ) otherwise\end{matrix} \\ \frac{2}{N} \cdot R \cdot exp ( ξ ) \cdot \frac{1 - {R}^{K} \cdot exp ( K \cdot ξ )}{1 - R \cdot exp ( ξ )} otherwise .\end{matrix}$$

The method of directly transforming application data with a circulant matrix according to present invention is relatively fast and efficient because the method includes simply multiplying the circulant matrix by vector. The number of calculations necessary to obtain the entire first row of elements is proportional to N. This method is significantly faster than the method ‘ML’ and is significantly more robust than prior art methods even if the generated circulant matrix row is used for only a one time calculation.

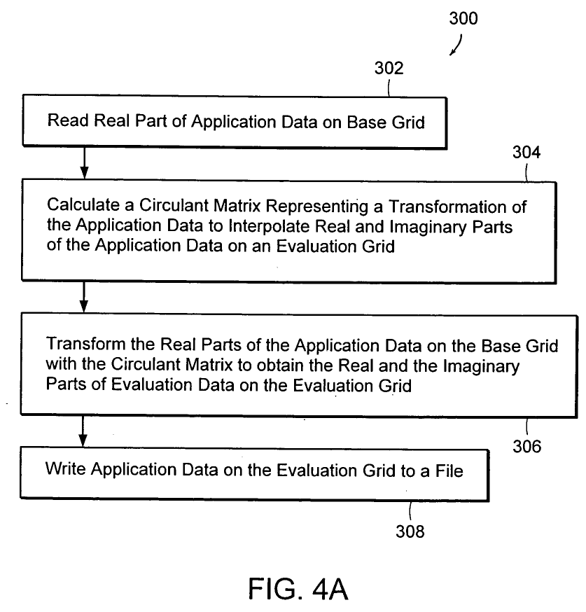

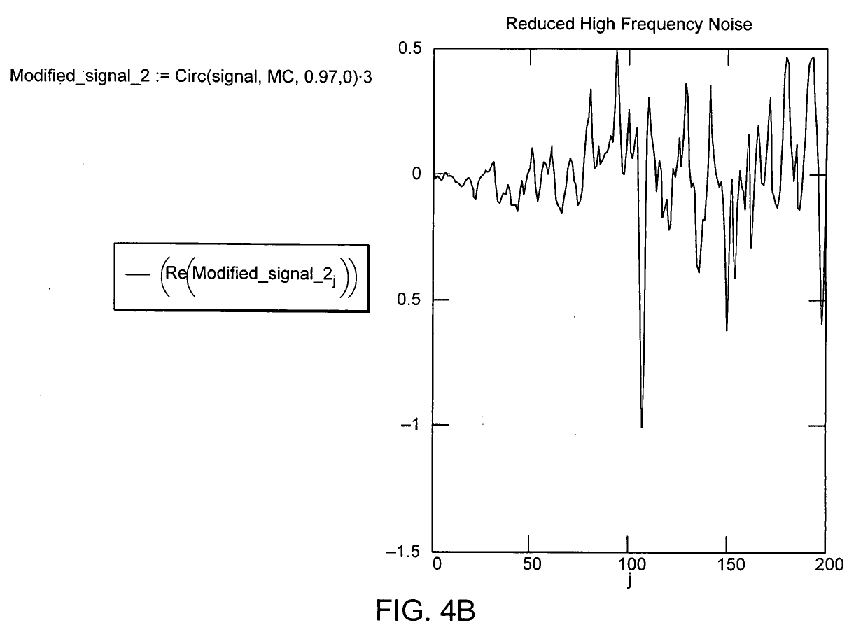

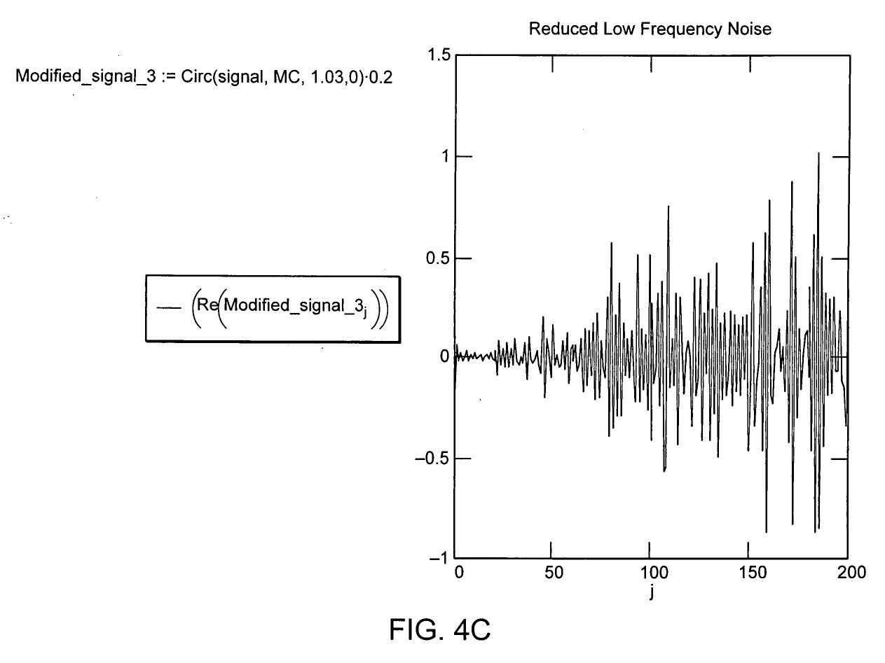

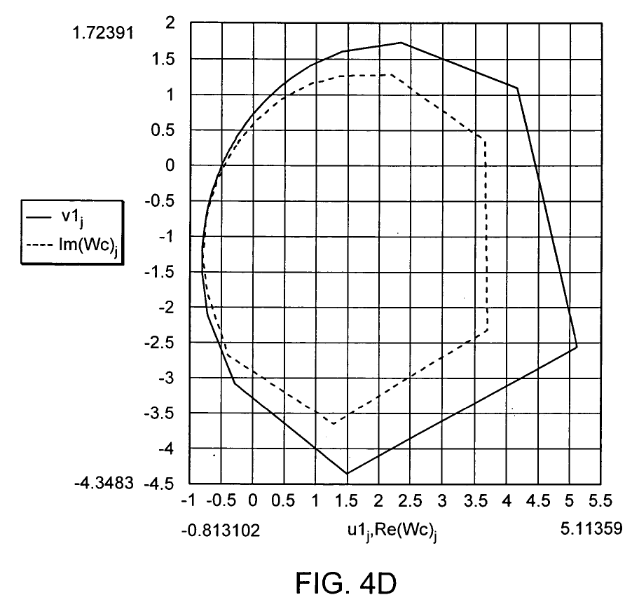

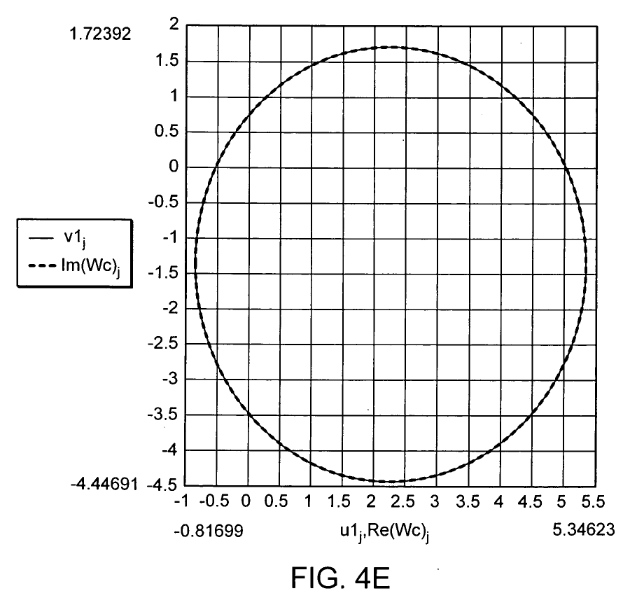

FIG. 4a is a flow chart of a method 300 of directly transforming application data with a circulant matrix according to the present invention. The method includes the step 302 of reading the application data. In one aspect of the present invention, the application data is the digital data representing of an experimental signal that is read from data sensor or an electronic data storage unit. The experimental signal is transformed to a signal having its amplitude-frequency changed according predetermined requirements. In another aspect of the present invention, circulant matrices are used to perform interpolation of analytical functions. In this embodiment, the application data is the real part of analytical function values on the base grid.

Step 304 includes calculating a circulant matrix that represents the transformation of application data Step 306 includes transforming the real part of the application data on the base grid with the circulant matrix in order to obtain the real and the imaginary parts of the evaluation data on the evaluation grid. Step 308 includes writing the real and imaginary parts of the evaluation data on the evaluation grid to a file.

The real and the imaginary parts of the evaluation data on the evaluation grid can then be determined to evaluate continuation details in a desired area on the evaluation grid. The evaluation of the continuation details enables the user to study the behavior of the analytical function for which the interpolation results were obtained. In one embodiment of the invention, the veracity of the real and the imaginary parts of the evaluation data on the evaluation grid is evaluated and this evaluation is used to determine if changes in the evaluation grid or the number of points in the data sample are necessary.

FIGS. 4B and 4C illustrate transformations of the exemplary waveform signal of FIG. 3A using the method that is described in connection with FIG. 4A. FIG. 4B illustrates a transformation of the exemplary waveform signal that achieves a reduction in high-frequency noise with the transformation Modified_signal_{—}2=Circ(signal, MC, 0.97,0)*3. FIG. 4C illustrates the transformation of the exemplary waveform signal to achieve a reduction in low-frequency noise with the transformation Modified_signal_{—}3=Circ(signal, MC, 1.03,0)*0.2. Only the real part is shown in both FIGS. 4B and 4C.

FIGS. 4D and 4E illustrate analytical function evaluation or interpolation results obtained using the method that is described in connection with FIG. 4A. In the example illustrated, real part values on the unit circle uᵢ=Real(w(zi)) were obtained for an analytical function w(z):=((z)+0.54i+0.9)⁻¹ and R:=0.9, ψ:=0.3. The values for the analytical function were obtained using the method Wc:=Circ(u, MC, μ, ψ), which takes ‘u’ as an input signal and performs method ‘MC’ to generate the circulant matrix. The parameters of transformation for the method “MC” are ‘R’, and ‘ψ’. In this example, ‘u’ is a real part value of a given analytical function on the base grid. The method ‘MC’ is used to interpolate an analytical function on an evaluation grid based upon real part values on the base grid. The ratio ‘R’ is a ratio of an evaluation grid radius to the base grid radius, and ‘ψ’ is the difference between arguments of an evaluation grid starting point and the base grid starting point.

The method Circ generates the circulant matrix row and then computes the multiplication of the generated circulant matrix-to-vector containing the input signal. The result of the circulant matrix-to-vector multiplication is the vector containing interpolated values on the given evaluation grid. In this example, u1 and v1 are values that are obtained directly from the analytical function as u1ⱼ:=Re(w(z1ⱼ))v1ⱼ:=Im(w(z1ⱼ)), where z1ⱼ:=R·exp[1i·(ωⱼ+ψ)], and the values Wcⱼ were obtained from the method Wc:=Circ(u, MC, μ, ψ).

FIG. 4D illustrates an analytical function evaluation using 50 data points. The analytical function evaluation using 50 data points indicates that a 50-point data sample is not enough to evaluate the function with a high degree of accuracy. FIG. 4E illustrates an analytical function evaluation using 250 data samples. The analytical function evaluation using 250 data samples appears to have a high-degree of accuracy. The desired number of data samples depends upon the desired accuracy and the particular application.

In one embodiment, all the frequency weights are equal to the same constant, R which is equal to unity and ψ is equal to π/2. In this embodiment, the first row of the transformation circulant matrix can be represented as follows:

$$MG ( n ) := \vert \begin{matrix}\frac{cos ( \frac{π}{N} \cdot - n ) \cdot [ 1 - {( - 1 )}^{n} ]}{N \cdot sin ( \frac{π}{N} \cdot - n )} if odd ( N ) = 0 \\ \frac{cos ( \frac{π}{N} \cdot - n ) - {( - 1 )}^{n}}{N \cdot sin ( \frac{π}{N} \cdot - n )} otherwise .\end{matrix}$$

The method “MG” is similar to methods ML and MC that are described in connection with FIGS. 3 and 4. The method “MG” uses the CircG(u), where “u” is the real part value of a given analytical function on the base grid. The method CircG uses method ‘MG’ to generate the circulant matrix row and to compute the multiplication of the generated circulant matrix-to-vector containing the input signal. The result of the circulant matrix-to-vector multiplication is the vector containing interpolated values of the imaginary part on the same grid. The result will be denoted herein as ‘˜’. For example v:=˜(u) mean that vector ‘v’ is being obtained via described method.

This method very efficiently solves some harmonic equations. Other harmonic equations can be solved efficiently by using the following relationship between the Norm of the complex function W(z) and its argument: (φ(α)−α)=˜(0.5*Ln(norm(W(α)−W(0)))), where φ(α) is the argument of (W(α)−W(0)). In one embodiment, the efficiency is further improved by using the derivative of W to satisfy the following harmonic equation: (ψ(α)−(α+π/2))=˜(0.5*Ln(norm(W(α)′))), where ψ(α) is the tangent angle to boundary curve in W(α).

Imaginary values on the base grid are the values of the function that are the harmonic conjugate to the input signal, which is associated with the real values on the base grid. Harmonic conjugate functions are useful for solving harmonic equations and for finding dependencies between oscillatory types of data. The harmonic conjugate function can be found by one circulant matrix-to-vector multiplication.

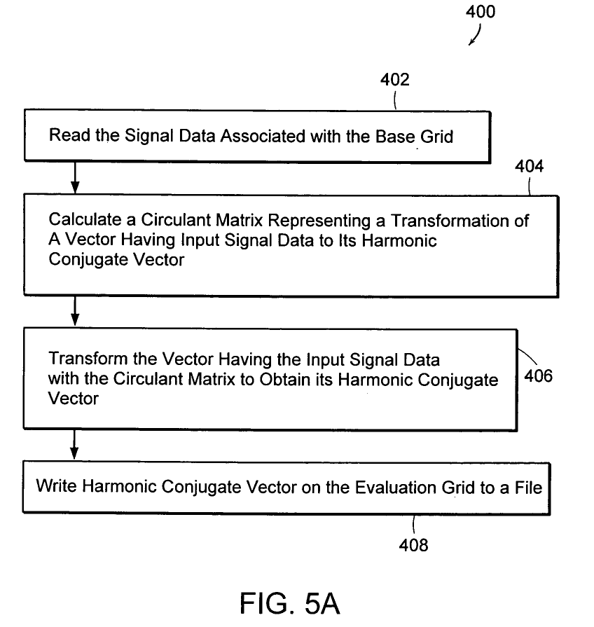

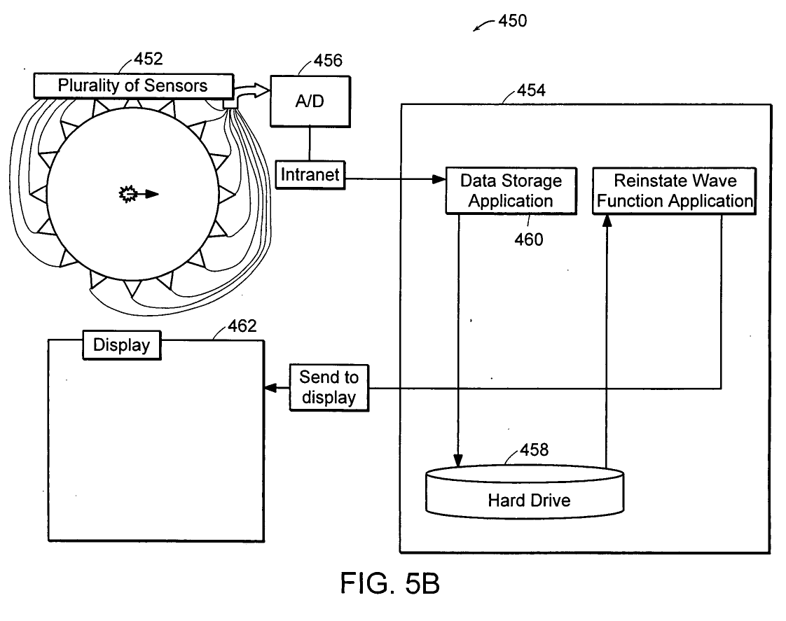

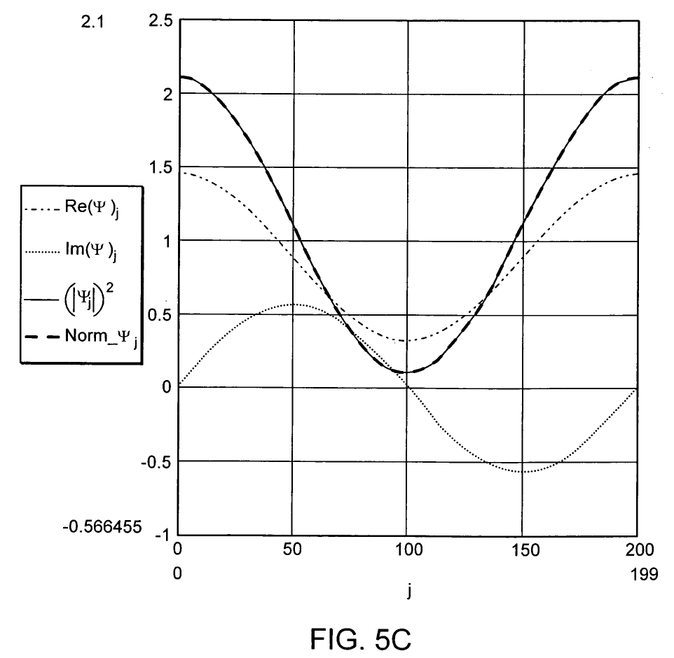

FIG. 5A is a flow chart of a method 400 of computing results of the ‘tilde’ operator according to the present invention. The first step 402 of the method 400 includes reading the signal data associated with the base grid. For example, the step of reading the signal data associated with the base grid can include processing a four hour range of fifteen minute intraday market data, processing two seconds of digital sound data and processing data read by a plurality of sensors.

The second step 404 includes calculating a circulant matrix that represents a transformation of a vector having the input signal data to its harmonic conjugate vector. The third step 406 includes transforming the vector having the input signal data with the circulant matrix to obtain its harmonic conjugate vector. The fourth step 406 includes writing the harmonic conjugate vector onto the evaluation grid.

FIG. 5B is a block diagram of a data acquisition and analysis system 450 according to the present invention that can be used to acquire function values and analyze them to reinstate a function. A plurality of sensors 452 are used to acquire physical data that represents probability density measurements. Any type of sensor can be used. For example, the plurality of sensors 452 can be used to acquire physical data for electrostatic, magneto static, hydrodynamic, thermo conducting problems, medical imaging/brain maps The plurality of sensors 452 converts the raw data to electrical signals. The plurality of sensors 452 are electrically coupled to a processor or a computer 454. In some embodiments, the electrical signals are transmitted to the computer 454 through an intranet or the Internet.

In some embodiments, the electrical signals are analog signals that need to be converted to digital signals for data storage and data processing. An analog-to-digital converter 456 is used to convert the analog data signals generated by the plurality of sensors to digital data signals. The computer 454 reads the digital data signals. In some embodiments, the computer 454 stores the digital data signals for future processing. The digital data can be stored directly as a file on a data storage device 458 that is in communication with the computer 454 or can be stored in a data storage application 460 that executes on the computer 454.

The computer 454 executes an application that determines analytical function data from the measurement represented by the digital data using a method of the present invention, such as the method that is described in connection with FIG. 5A. The analytical function data is then stored on the data storage device 458 or is displayed on a display 460.

The methods and apparatus that are described in connection with FIGS. 5A and 5B can be used to determine a wave function from a probability density measurement. Wave functions are complex analytical functions that are fundamental to quantum mechanics. The probability density of a particle being in a particular point is the norm of the wave function. The norm of the wave function can be measured experimentally as described in connection with FIG. 5B. The entire wave function can be obtained from the ˜ operator and the method of solving harmonic equation. The wave function obtain in the unit circle from experimental data on unit circle surrounding the particle is:

$$Ψ ( ζ ) := \sqrt{{( \vert Ψ ( ζ ) \vert )}^{2}} \cdot {ⅇ}^{ⅈ \cdot CircG [ ln [ \sqrt{{( \vert Ψ ( ζ ) \vert )}^{2}} ] ]}$$

where Ψ(ζ) is the wave function, and (|Ψ(ζ)|)² denotes its norm.

In applications where it is not possible to have a round shape, an analytical function mapping unit circle to the given shape can be obtained. Sensors should be distributed along the given curve according to density distribution, which was previously found. Data from such distributed sensors can then be associated with the base grid and processed by the disclosed methods.

FIG. 5C is a graphical illustration of an exemplary wave function that is calculated from a probability density measurement according to the present invention. The sample data were obtain for a circle having center coordinate (0,0) and an impulse direction on the X-axis. The radius of the circle is a unit of distance measurement. The experimental data for the probability density measurement is as follows:

$${Norm\_Ψ}_{j} := cos ( j \cdot \frac{2 \cdot π}{N} ) + 1.1 .$$

An intermediate vector is calculated as LnRⱼ:=ln(\sqrt{Norm_Ψⱼ}). The intermediate vector is used to calculate the phase function ω:=CircG(LnR). The wave function of the particle is Ψⱼ:=\sqrt{Norm_Ψⱼ}·e^{1i·(ω}^{ⱼ}^{-ω}^{₀}⁾. The norm of the complex function is given by the experimental data. The function can be evaluated using the method described in connection with FIG. 4A. The function in space can be re-instated using symmetry.

The method described in connection with FIG. 5A can also be used to perform conformal mapping of a unit circle to a simply connected area. A numerical approximation of the conformal mapping of a unit circle to a simple-connected area Ω is obtained from the distribution of the images in the boundary ζ of Ω, of the evenly distributed points in the unit circle.

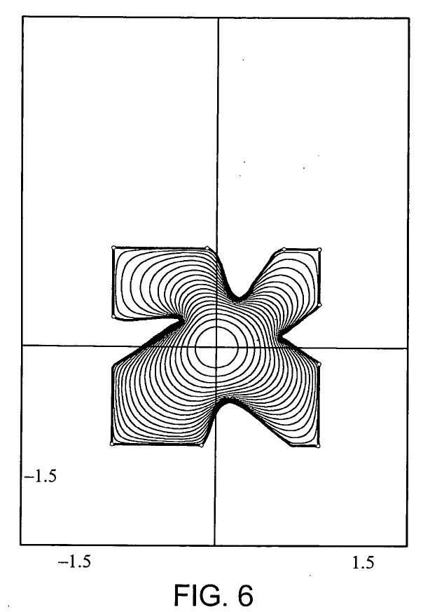

FIG. 6 illustrates exemplary data obtained by conformal mapping using the method that is described in connection with FIG. 5A. Conformal mapping is often used for solving mathematical physics problems and is well known in the art. The exemplary data illustrated in FIG. 6 is a numeric representation of periodical functions U=u(s(j)) and V=v(s(j)), where s(j)=j*2π/N, and jε[0,N−1] is an integer. The functions represent numerical approximation of a simple connected area's boundary ζ. The complex function w(s(j))=u(s(j))+i*v(s(j)) can be constructed so that values of that complex function on the base grid represent ζ in a complex plane. Then we find a re-parameterization as a monotonically growing function, T=t(s), t(0)=0; t(2π)=2π. The re-parameterization function T is determined to satisfy the following harmonic equation: v(t(s(j)))=˜u(t(s(j))) numerically.

The re-parameterization function T is found through an iterative process where for a given Tₖ(j), v(s(j)) and u(s(j)), the next Tₖ₊₁(j) is calculated. The method of solving a harmonic equation uses the relation between the modulus function value and its argument as well as the relationship between the modulus of the derivative function value and its argument.

A non-satisfaction function is calculated to determine how much one needs to inflate or deflate the norm of the derivative (probability density) around a particular point on the curve relative to the existing norm of the derivative value. The non-satisfaction function value indicates how much the norm of the derivative value for a particular point is less than or greater than needed in order for the function to be analytical. For example, if infl(j) is equal to unity, then the density requirement is satisfied in that particular point. However, if infl(j) is less than unity, then the norm of the derivative value should be increased. If infl(j) is greater than unity, then the norm of the derivative should be decreased. Such transformation of the t(s) completes the iteration step.

In the first step, t(s) is taken as t(s)=s. The iteration is done via consecutive steps of calculating the non-satisfaction function in the following way:

For jε[0; N−1],
infl(j)=exp[˜((a_(j)−(π/2+j*2π/N))−(a(j)−j*2π/N))]*sqrt[norm(w′(j))/norm(w(j)−w0)];
infl*=(N/sqrt(norm(infl)), where N is the number of points and infl are the non-satisfaction function values where at) is the argument of w(j)−w0 and a_(j)−j*2π/N is the argument of w′(j). Also, w(j) and its derivative w′(j) functions are complex number. The function norm(a+ib) is equal to a*a+b*b. The algorithm in this example converges exponentially and typically there are only several iterations needed to obtain a solution with a very high accuracy.

When the norm of the dissatisfaction function is less than a predetermined tolerance, the points with coordinates {u(t(s(j))), v(t(s(j)))} resemble an image (having the predetermined tolerance) of the base grid that is reflected by a function that is analytical inside a unit circle. Therefore, the grid spacing, according to distribution function t(s(j)), resembles an image of the base grid that is reflected by a function that is analytical inside a unit circle with the predetermined tolerance. The conformal map of FIG. 6 illustrates projections of the concentric circles with radii that are equal to r=sqrt(double(i)/20*(2−double(i)/20)); where i=1, . . . 20.

The conformal mapping of the present invention is more computationally efficient and is more accurate than prior art methods. The conformal mapping of the present invention is not limited to known analytical functions (like Jukovsky's function, which is commonly used for solving fluid dynamic problems). The conformal mapping of the present invention can perform conformal mapping for simple-connected arbitrary areas with eccentricity that is less than 1 to 10. In addition, the conformal mapping of the present invention is relatively fast for an arbitrary number of points and not just for powers of two.

Conformal mapping using the method that is described in connection with FIG. 5A can be used to recalculate Green's function values that are obtained for a given linear and differential operator on the unit circle. It is well known in the art how to use conformal mapping from a simple-connected domain to a unit circle to solve a variety of mathematical physics problems. In one embodiment, the method that is described in connection with FIG. 5A performs reverse conformal mapping, which is the mapping from a unit circle to the simple-connected domain.

In one embodiment, the method that is described in connection with FIG. 5A is used to create an interpolation mesh for the analytical function. Creating the mesh can be performed by constructing the conformal map from a unit circle to the simple-connected domain for any radius inside the radius of convergence. Building a mesh for the entire region can be accomplished in N*N*log2(N) number of calculations. The calculations construct a unit circle to a simple-connected domain mapping. Table interpolation methods that are known in the art can then be used to determine the simple-connected domain to a unit circle mapping. Known methods can then be used for the simple-connected arbitrary areas with eccentricity that is less than 1 to 10. Function composition methods that are known in the art can allows an even wider variety of domains.

In one aspect of the present invention, dependencies between oscillatory-type data are determined by computing harmonic ratios and harmonic correlations using the tilde operator shown below.

$$tilde ( u , v ) := \vert \begin{matrix}mu ← mean ( u ) \\ mv ← mean ( v ) \\ \frac{2}{N} \cdot ( ( u - mu ) \cdot ( v - mv ) + 1 i \cdot ( u - mu ) \cdot CircG ( v - mv ) ) ,\end{matrix}$$

where ‘CircG(v)’ is the imaginary part of data that is defined by CircG(v)≡(˜v).

The properties of the tilde operator are:
(α+i*β)˜u=α*u+β*(˜u);
λ˜u=u˜conj(λ);
u˜v=conj(v˜u);
u˜(λ˜x+μ˜y)=conj(λ)*(u˜x)+conj(μ)*(u˜y),
where α, β are real numbers; λ and μ are complex numbers; and u, v, x and y are vectors that have the same length.

The harmonic correlation operator HC(u,v) of the present invention is similar to the prior art “correlation coefficient.” The harmonic correlation operator HC(u,v) can be used to find a ratio of tightness. In one embodiment, the harmonic correlation operator HC(u,v) is:

$$HC ( u , v ) := \vert \begin{matrix}mu ← mean ( u ) \\ mv ← mean ( v ) \\ \frac{tilde ( u - mu , v - mv )}{\frac{2}{N} \cdot \sqrt{( ( u - mu ) \cdot ( u - mu ) \cdot ( ( v - mv ) \cdot ( v - mv ) ) )}} .\end{matrix}$$

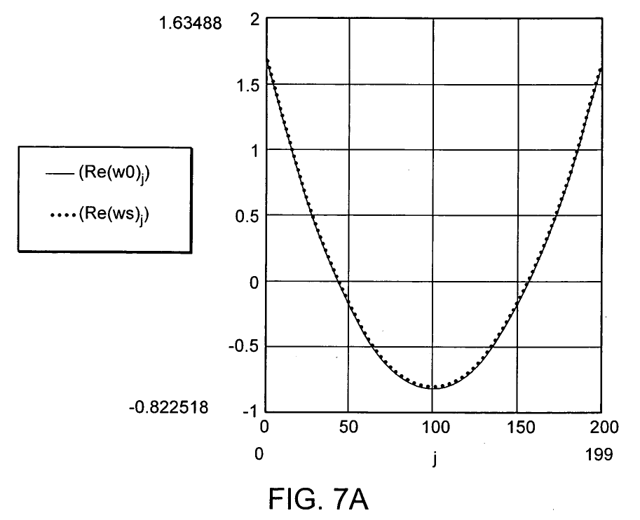

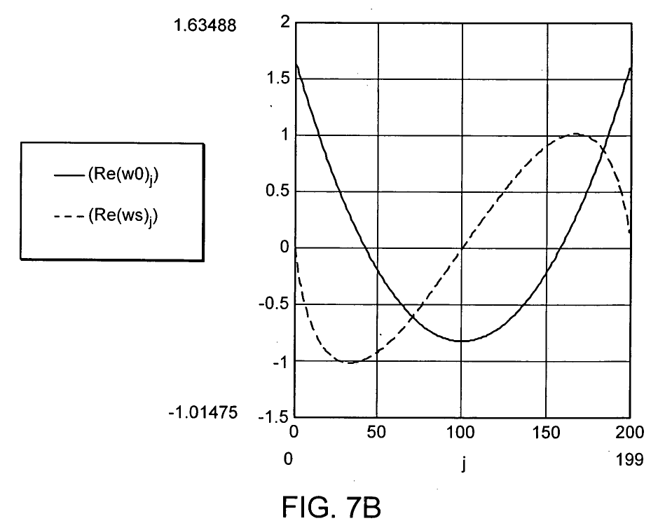

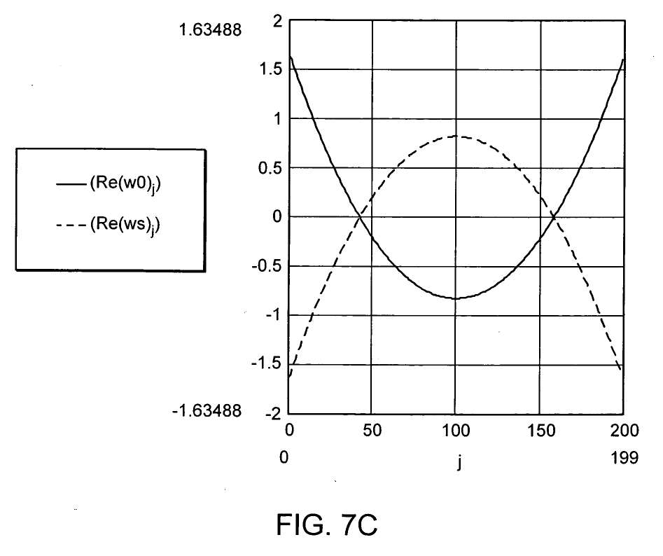

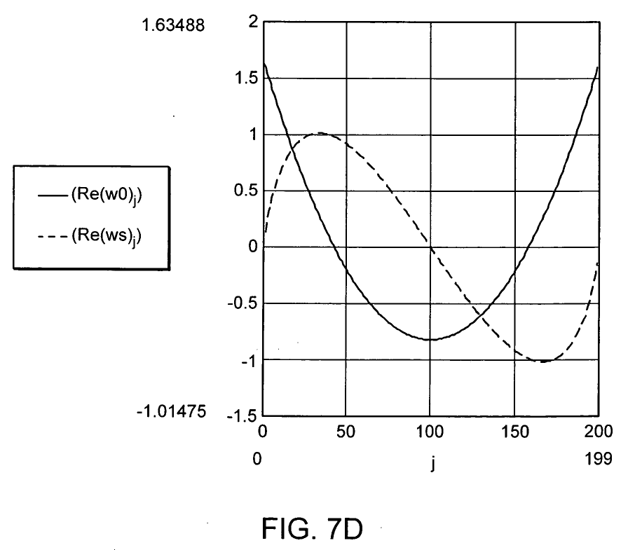

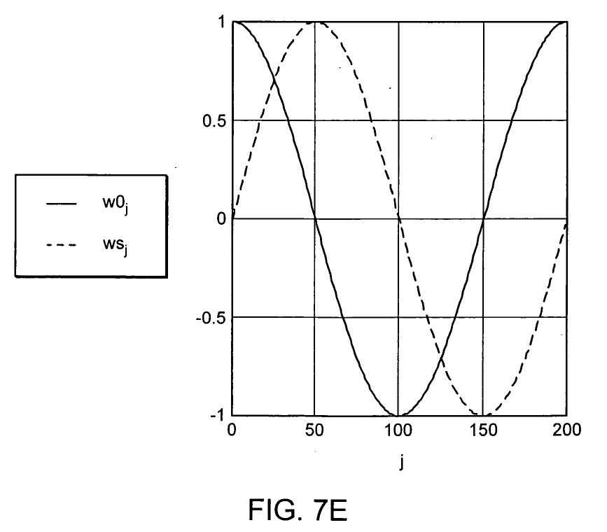

FIG. 7A-D illustrates exemplary harmonic ratio data that was obtained using a harmonic correlation method according to the present invention. In this example, the function is chosen to be:

$${w0}_{j} := [ {\sum }_{t = 1}^{K} \frac{1}{t \cdot t} \cdot cos ( \frac{j \cdot t \cdot 2 \cdot π}{N} ) + \frac{1 i}{t \cdot t} \cdot sin ( \frac{j \cdot t \cdot 2 \cdot π}{N} ) ] .$$

The function values are rotated in the complex area.

FIG. 7A illustrates data for a zero turning angle, which is represented as wsⱼ:w0ⱼ·e⁰ⁱ. The argument and harmonic correlation operator can be represented as:
arg(tilda(Re(w0),Re(ws)))=5.206·10⁻¹⁷ HC(Re(w0),Re(ws))=1+4.796·10⁻¹⁷i.

FIG. 7B illustrates data for a turning angle that is equal to 1.57, which is represented as wsⱼ:=w0ⱼ·e^{1.57i}. The argument and harmonic correlation operator can be represented as:
arg(tilda(Re(w0),Re(ws)))=1.57 HC(Re(w0),Re(ws))=7.963·10⁻⁴+i.

FIG. 7C illustrates data for a turning angle that is equal to 3.14, which is represented as wsⱼ:=w0ⱼ·e^{3.14i}. The argument and harmonic correlation operator can be represented as:
arg(tilda(Re(w0),Re(ws)))=3.14 HC(Re(w0),Re(ws))=−1+1.593·10⁻³i.

FIG. 7D illustrates data for a turning angle that is equal to −1.57, which is represented as wsⱼ:=w0ⱼ·e^{-1.57i}. The argument and harmonic correlation operator can be represented as:
arg(tilda(Re(w0),Re(ws)))=−1.57 HC(Re(w0),Re(ws))=7.963·10⁻⁴−i.

The data illustrated in FIGS. 7A-D show that the argument of the harmonic ratio reflects the rotation angle in the complex plane between two analytical functions given by their real part values on the base grid. The level of correlation between the two analytical functions is reflected by the modulus of the harmonic ratio. The harmonic ratio data obtained using the methods of the present invention reveal more information about the tightness of the signal. FIG. 7E shows exemplary functions having ratios that are equal to imaginary unit: ws˜w0=1i, and w0˜ws=−1i.

In one embodiment of the present invention, harmonic ratios are used to diagonalize a Hermitian matrix. In another embodiment, the method of harmonic correlation according to the present invention is used to sort market data to find indexes with behavior that is similar to particular market indexes. The data was first sorted by using the prior art correlation coefficient and then was sorted by using the harmonic correlation coefficient of the present invention.

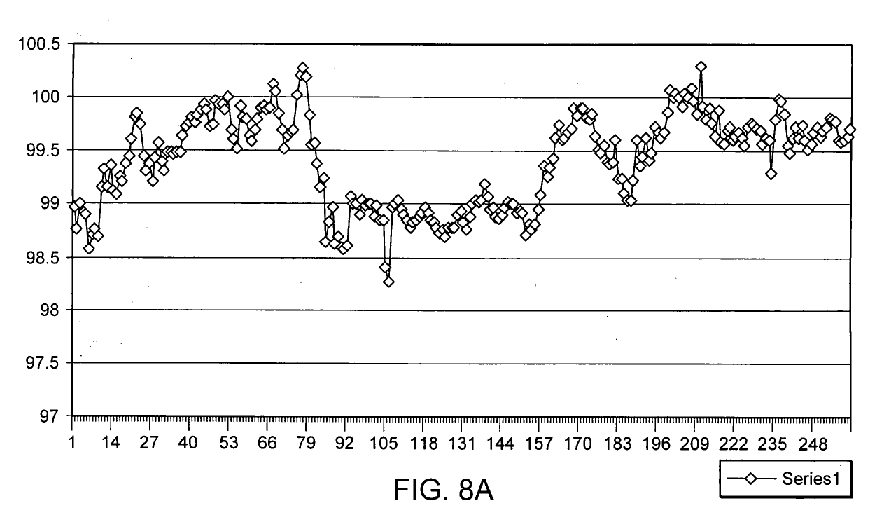

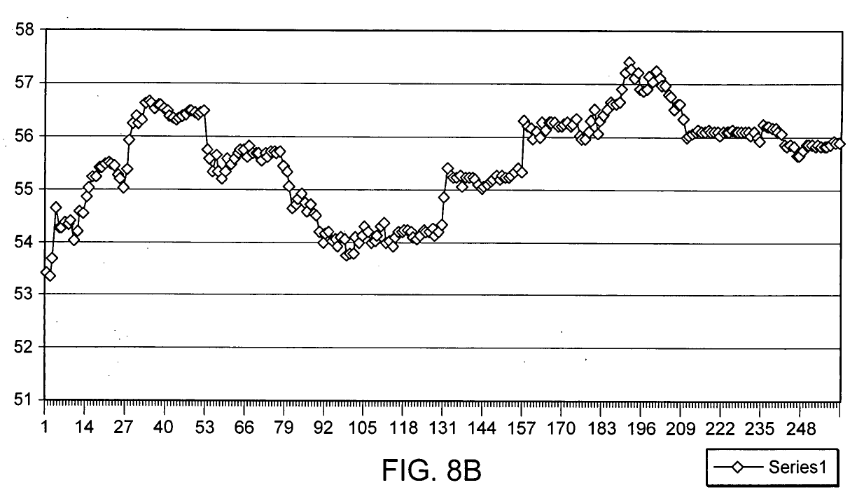

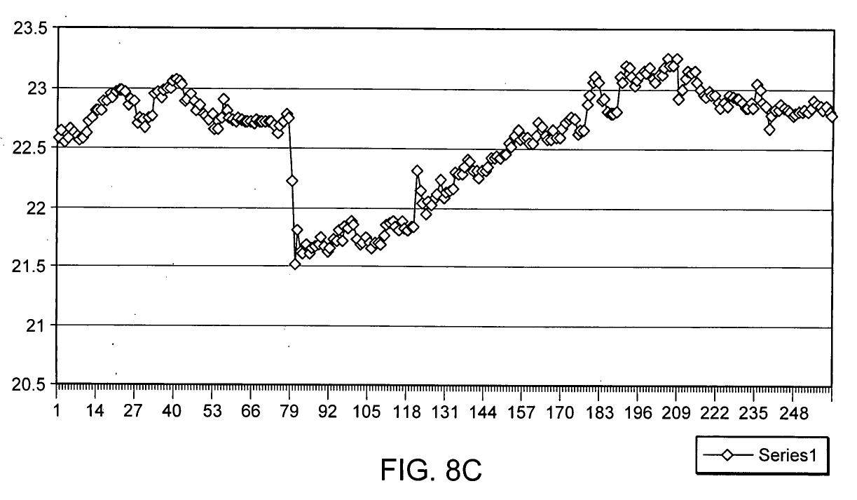

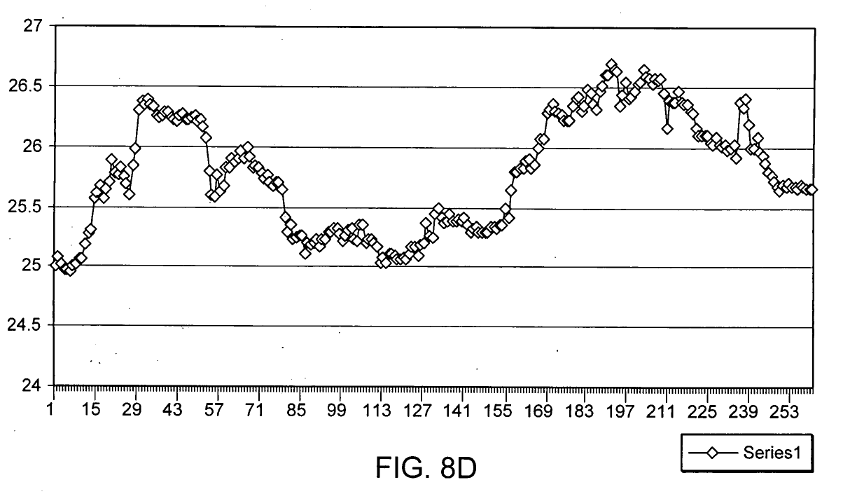

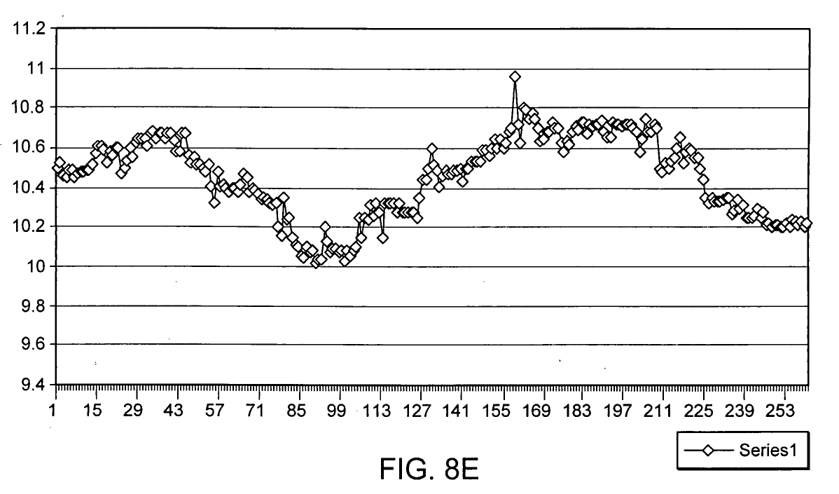

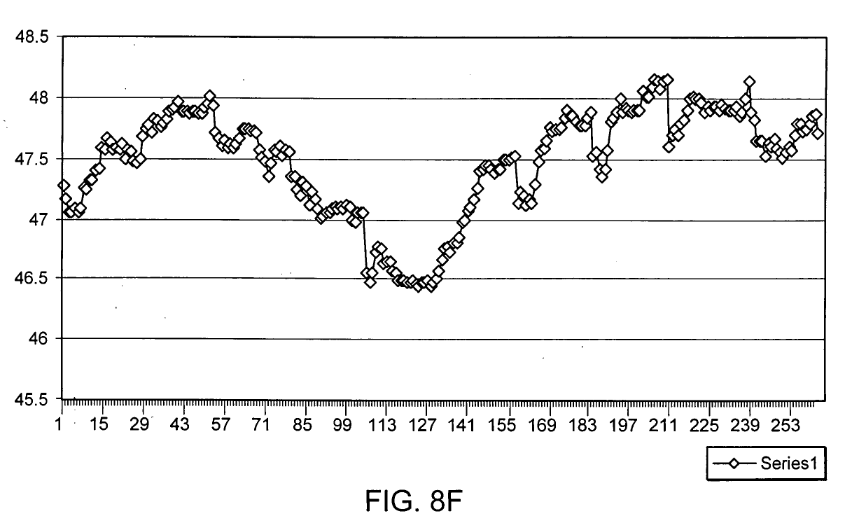

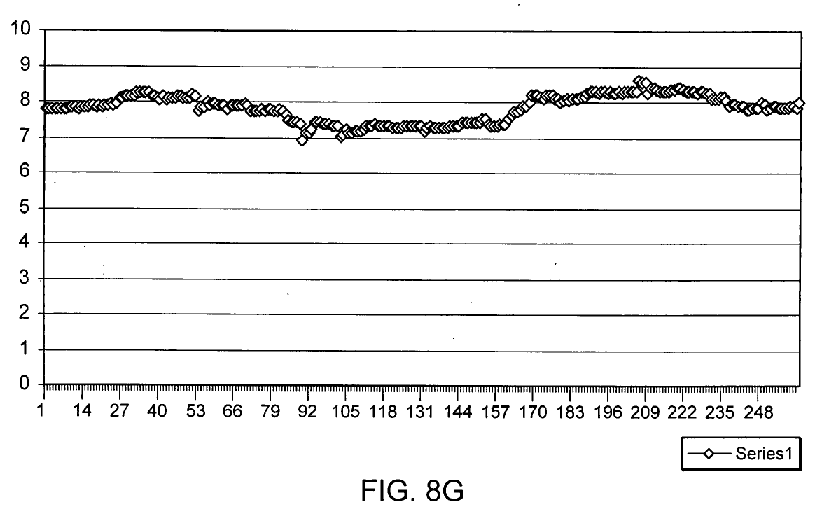

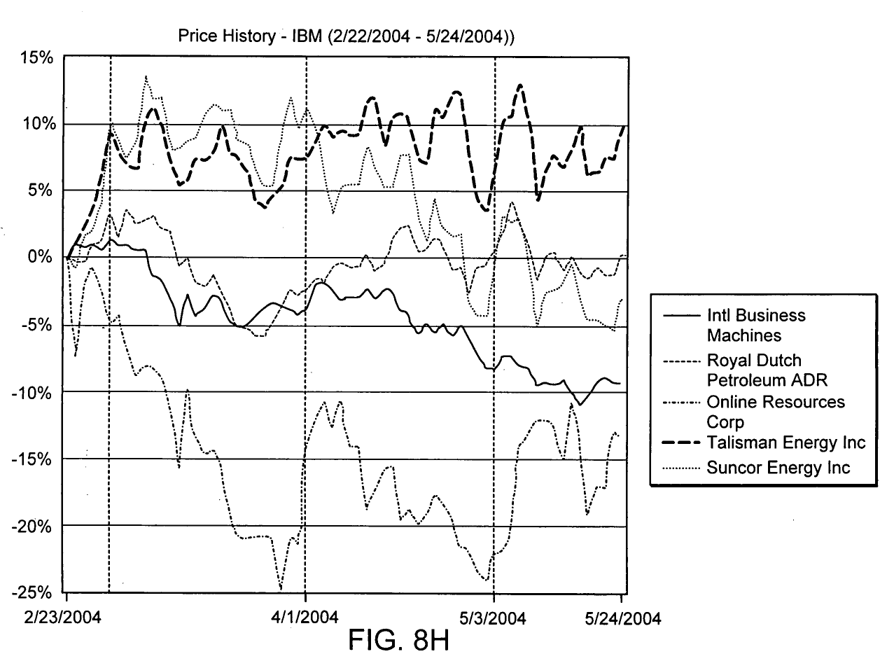

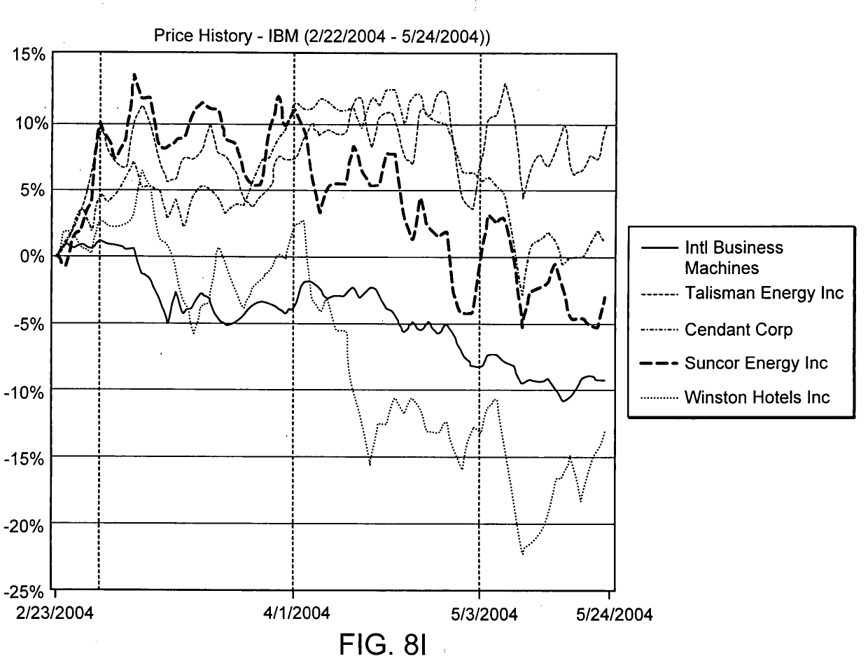

FIGS. 8A-G illustrate market data for seven companies in various industries selected from thousands of companies that were analyzed using the method of harmonic correlation described herein. The market data is share price data at fifteen minute intervals for a two week time period. The market data was selected from a database that included approximately 20,000 companies. Data filters were used to remove market data for companies that had relatively low trading volume. The result of the data filtering was that about 5,000 indexes with strong trades were analyzed.

FIG. 8A illustrates International Business Machine (IBM) share price data at fifteen minute intervals for a two week time period. FIG. 8B illustrates Talisman Energy Inc. share price data at fifteen minute intervals for a two week time period. FIG. 8C illustrates Cendant Corporation (CD) share price data at fifteen minute intervals for a two week time period. FIG. 8D illustrates Suncor Energy Inc. share price data at fifteen minute intervals for a two week time period. FIG. 8E illustrates Winston Hotels, Inc. share price data at fifteen minute intervals for a two week time period. FIG. 8F illustrates Royal Dutch Petroleum Company share price data at fifteen minute intervals for a two week time period. FIG. 8G illustrates Online Resources Corporation share price data at fifteen minute intervals for a two week time period.

FIG. 8H shows top five indexes in sorting results using the prior art correlation method. The share price data for the 5,000 indexes were sorted relative to IBM using a prior art correlation method. The sorting using the prior art correlation method resulted in the following order: (1) IBM; (2) Royal Dutch Petroleum Corporation; (3) Online Resources Corporation; (4) Talisman Energy, Inc.; and (5) Suncor Energy, Inc. FIG. 8F illustrates a three month chart that was prepared by “MSN Money” that shows a −20% to +25% variation in the share price data.

FIG. 8I illustrates sorting results for the top five indexes using the harmonic correlation method of the present invention. The share price data for the 5,000 indexes were sorted by the norm of the harmonic correlation relative to IBM. The harmonic correction was determined using the methods of the present invention. The sorting by the norm of the harmonic correlation resulted in the following order: (1) IBM; (2) Talisman Energy, Inc.; (3) Cendant Corporation; (4) Suncor Energy, Inc.; and (5) Winston Hotels, Inc. FIG. 8G illustrates a three month chart that was prepared by “MSN Money” that shows a 8% to +14% variation in the share price data.

The sorting results shown in FIG. 81 indicate a smaller variation in the share price data among those selected using the method of harmonic correlation of the present invention. Thus, the sorting results shown in FIG. 81 indicate that the method of harmonic correlation according to the present invention is a more efficient sorting method than the prior art correlation method.

Share price data is oscillatory in nature. There are many variables that influence share price data. Each of the companies has a set of dominant variables that most strongly influence the share price. The dominant variables for a particular company can be in-phase or out-of-phase with the dominant variables of other companies. The method of harmonic correlation according to the present invention has relative high sorting efficiency when the data includes signals having the same dominant variables influencing the signals with different phase.

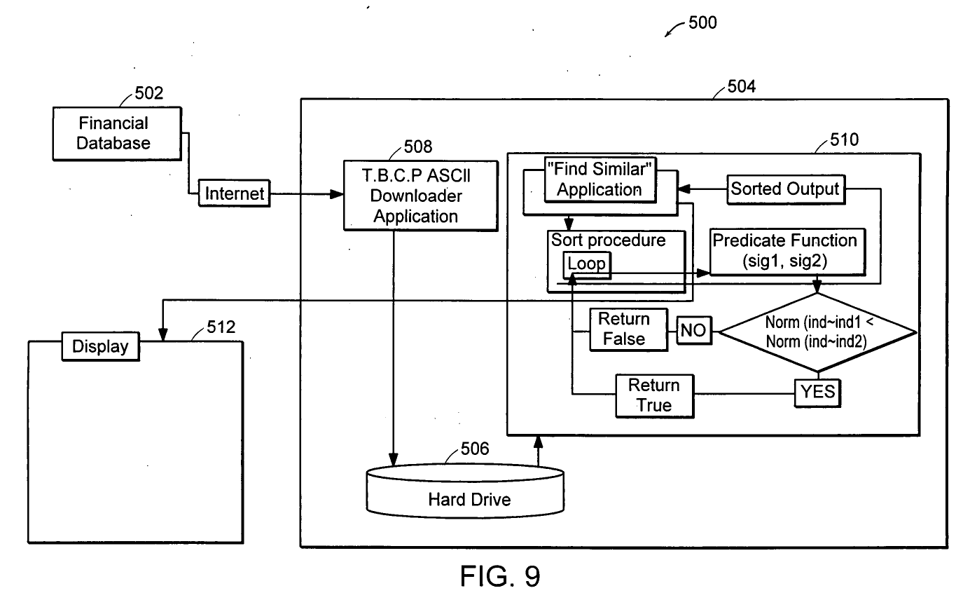

FIG. 9 is a block diagram of a data acquisition and analysis system 500 according to the present invention that can be used to acquire and analyze financial data to identify companies having similar stock price behavior. The system 500 includes a financial database 502. Numerous financial databases are commercially available. The system 500 can be interfaced with the financial database 502 in many different ways. For example, the system 500 can interface with the financial database 502 through the Internet or can interface with the financial database though an intranet that is in communication with a data storage device that stores financial data.

The system 500 includes a processor or computer 504. In one embodiment, the computer 504 stores the financial database on a storage device that is in direct communication with the computer 504, such as a hard drive 506 that interfaces with the computer 504. In one embodiment, the computer 504 executes an ASCII downloading application program 508 that receives the financial data in ASCII format and sorts the ASCII data in a format that is suitable for processing. The formatted financial data is then stored on a storage device, such as the hard drive 506 within the computer 504 or a storage device that is in communication with the computer 504 via a network.

The computer 504 executes an application 510 that uses the method of harmonic correlation according to the present invention and a sorting algorithm to sort the financial data. An exemplary flow chart of the application is shown. The resulting sorted data can be displayed in a display 512 or can be stored for further analysis or display in the future. In some embodiments, the computer 504 executes other applications to analyze the sorted data.

In one aspect of the present invention, harmonic ratios are used to diagonalize a Hermitian matrix. The Jacobi method of diagonalizing a Hermitian matrix of ratios is well known. The Jacobi method uses a sequence of similarity transformations with plane rotation matrices. Each of the similarity transformations makes a larger than average off-diagonal element (and its transpose) equal to zero. The similarity transformations corresponds to substituting the pair (having the ratio) with a pair of orthogonal vectors, thus reducing the sum of the off-diagonal elements in the matrix of ratios. In practice, the similarity transformations is done by finding coefficients for two vectors u & v, so that a new pair of vectors: λ₀u+μ₀v and λ₁u+μ₁v were orthogonal. The 2×2 matrix is called “orthogonalization matrix”.

The method of using harmonic ratios to diagonalize a Hermitian matrix according to the present invention uses the tilde operator in the following way:

$$tuu := tilde ( u , u ) tuv := tilde ( u , v ) tvv := tilde ( v , v )$$

$$ABS := 4 \cdot \vert {tuv}^{2} \vert {S}_{0} := \sqrt{{( tuu - tvv )}^{2} + 4 \cdot tuv \cdot \overline{tuv}} + ( tuu - tvv )$$

$${S}_{1} := \sqrt{{( tuu - tvv )}^{2} + 4 \cdot tuv \cdot \overline{tuv}} - ( tuu - tvv )$$

$$\begin{matrix}{λ}_{0} & {μ}_{0} \\ {λ}_{1} & {μ}_{1}\end{matrix}$$

$${ϕ}_{0} := arg ( tuv ) {ϕ}_{1} := π + {ϕ}_{0} ind := 0 … 1$$

$${R}_{ind} := \sqrt{\frac{ABS}{ABS + {( {S}_{ind} )}^{2}}} \qquad {λ}_{ind} := \sqrt{\frac{{( {S}_{ind} )}^{2}}{ABS + {( {S}_{ind} )}^{2}}} \qquad {μ}_{ind} := {R}_{ind} \cdot {ⅇ}^{ⅈ \cdot {ϕ}_{ind}} .$$

Assuming the following two vectors:

$${u}_{j} := [ {\sum }_{t = 1}^{1} \frac{1}{t \cdot t} \cdot cos ( \frac{j \cdot t \cdot 2 \cdot π}{N} ) + \frac{1}{t \cdot t} \cdot sin ( \frac{j \cdot t \cdot 2 \cdot π}{N} ) ]$$

$${v}_{j} := {\sum }_{t = 1}^{1} \frac{1}{t} \cdot cos ( \frac{j \cdot t \cdot 2 \cdot π}{N} )$$

then the tilde operator is as follows:

$$tuu = 2 tuv = 1 + i tvv = 1 λ = ( \begin{matrix}0.816 \\ 0.577\end{matrix} ) μ = ( \begin{matrix}0.408 + 0.408 i \\ - 0.577 - 0.577 i\end{matrix} ) \vert .$$

Thus, the method multiplies a complex number by vector as shown below:
x:=(λ₀)·u+Re(λ₀)·v+Im(μ₀)·CircG(v) y:=λ₁·u+Re(μ₁)·v+Im(μ₁)·CircG(v).

In another example:

$${u}_{j} := [ {\sum }_{t = 1}^{2} \frac{1}{t \cdot t} \cdot cos ( \frac{j \cdot t \cdot 2 \cdot π}{N} ) + \frac{1}{t \cdot t} \cdot sin ( \frac{j \cdot t \cdot 2 \cdot π}{N} ) ]$$

$${v}_{j} := {\sum }_{t = 1}^{2} \frac{1}{t} \cdot cos ( \frac{j \cdot t \cdot 2 \cdot π}{N} ) . \\ Then tuu = 2.125 tuv = 1.125 + 1.125 i tvv = 1.25 λ = ( \begin{matrix}0.795 \\ 0.606\end{matrix} ) μ = ( \begin{matrix}0.429 + 0.429 i \\ - 0.562 - 0.562 i\end{matrix} ) \vert \\ x := ( {λ}_{0} ) \cdot u + Re ( {μ}_{0} ) \cdot v + Im ( {μ}_{0} ) \cdot CircG ( v ) y := {λ}_{1} \cdot u + Re ( {μ}_{1} ) \cdot v + Im ( {μ}_{1} ) \cdot CircG ( v ) .$$

Equivalents

While the invention has been particularly shown and described with reference to specific preferred embodiments, it should be understood by those skilled in the art that various changes in form and detail may be made therein without departing from the spirit and scope of the invention as defined herein.

1. A method of performing a direct discrete transformation of a signal:
a) acquiring a signal having amplitude-frequency characteristics;
b) associating the signal with a base grid having a number of sample points to form a digital representation of a function having a discrete Fourier representation;
c) calculating a circulant matrix representing a transformation of the signal to a complex signal having real and imaginary parts that represent the signal having transformed amplitude-frequency characteristics;
d) transforming the signal with the circulant matrix, thereby obtaining real and imaginary parts of the signal having transformed amplitude-frequency characteristics; and
e) writing the real and imaginary parts of the signal to at least one of a display and a storage unit.

2. The method of claim 1 wherein the acquiring the signal having amplitude-frequency characteristics comprises acquiring the signal from a sensor.

3. The method of claim 1 wherein the acquiring the signal having amplitude-frequency characteristics comprises reading signal data from an electronic data storage unit.

4. The method of claim 1 wherein the acquiring the signal having amplitude-frequency characteristics comprises reading application data according to a density distribution function.

5. The method of claim 1 further comprising changing the number of sample points on the base grid in response to a determined accuracy.

6. A method of directly interpolating application data with an analytical function, the method comprising:
a) acquiring real parts of application data;
b) associating the real parts of the application data with a base grid having a number of sample points to form a digital representation of an analytical function having a discrete Fourier representation;
c) calculating a circulant matrix representing a transformation of the real parts of the application data on the base grid to interpolate real and imaginary parts of the application data on an evaluation grid with a function that is analytical inside a unit circle, the evaluation grid having a center at zero, a radius that is inside a radius of convergence and an argument that is between zero and 2PI;
d) transforming the real parts of the application data on the base grid with the circulant matrix, thereby obtaining real and imaginary parts of evaluation data on the evaluation grid; and
e) writing the real and imaginary parts of the evaluation data on the evaluation grid to at least one of a display and a storage unit.

7. The method of claim 6 wherein the acquiring the real parts of application data comprises acquiring application data from at least one sensor.

8. The method of claim 6 wherein the acquiring the real parts of application data comprises reading application data from an electronic data storage unit.

9. The method of claim 6 wherein the acquiring the real parts of the application data comprises reading application data according to a density distribution function.

10. The method of claim 6 wherein the real parts of the application data on the base grid comprises a known Green's function obtained for a given linear and differential operator on the unit circle and the evaluation data comprises a desired Green's function for the given linear and differential operator on a simple connected area.

11. The method of claim 6 further comprising changing the number of sample points on the base grid in response to a determined accuracy.

12. The method of claim 6 further comprising evaluating the real and the imaginary parts of the evaluation data on the evaluation grid to determine continuation details in a desired area on the evaluation grid.

13. The method of claim 6 further comprising:
a) changing at least one of the argument and the radius;
b) calculating a second circulant matrix representing a transformation of the application data on the base grid to interpolate real and imaginary parts of data on a second evaluation grid; and
c) transforming the real part of the application data on the base grid with the second circulant matrix, thereby obtaining real and imaginary parts of evaluation data on the second evaluation grid.

14. The method of claim 13 wherein the real and imaginary parts of the evaluation data on the first evaluation grid and the real and imaginary parts of the evaluation data on the second evaluation grid comprise an evaluation mesh.

15. The method of claim 14 further comprising analyzing the real and imaginary parts of the evaluation data on the second evaluation grid to determine continuation details in a desired area on the evaluation mesh.

16. The method of claim 6 further comprising analyzing the real and imaginary parts of the evaluation data on the evaluation grid to determine an eccentricity of the interpolated application data.

17. The method of claim 16 further comprising changing a number of sample points on base grid in response to the determined eccentricity.

18. The method of claim 7 wherein a spacing of sensors providing the application data to be associated with the base grid is reduced proximate to an area of technical interest for the application.

19. The method of claim 6 wherein the calculating the circulant matrix representing the transformation of the real parts of the application data on the base grid is performed for a plurality of evaluation grids.

20. The method of claim 19 further comprising calculating a mesh of discrete representations of the analytical function to create a conformal map from a unit circle to a simple connected domain.

21. The method of claim 20 further comprising obtaining conformal mapping between two simple connected areas associated with two simple connected domains.

22. The method of claim 20 further comprising obtaining conformal mapping between two areas associated with one simple connected domain and a conformal mapping done by a known analytical function.

23. A method of directly determining harmonic conjugate values on a base grid, the method comprising:
a) acquiring application data on a base grid according to a density distribution function;
b) determining harmonic conjugate function values on the base grid using a tilde operator; and
c) writing the harmonic conjugate function values to at least one of a display and a storage unit.

24. The method of claim 23 wherein the harmonic conjugate function values comprise imaginary parts of the application data.

25. The method of claim 23 wherein the harmonic conjugate function values comprise polar coordinate application data.

26. The method of claim 23 further comprising determining a harmonic ratio between a first and a second sample of oscillatory data using imaginary parts of the application data on the base grid.

27. The method of claim 26 further comprising generating a Hermitian matrix from a plurality of harmonic ratios.

28. The method of claim 26 wherein the first and the second sample of oscillatory data are chosen from the group comprising financial data, scientific data, and seismology data.

29. The method of claim 23 wherein the application data comprises a probability density for a particle on the base grid.

30. The method of claim 23 further comprising calculating a dissatisfaction function to obtain an iteration correction for the density distribution function.

31. The method of claim 30 further comprising changing the density distribution function in response to the iteration correction and repeating the method until a norm of the dissatisfaction function is less than a predetermined tolerance.

32. The method of claim 31 wherein a grid spacing resembles an image of the base grid reflected by the analytical function inside a unit circle function having the predetermined tolerance.

33. The apparatus for directly interpolating application data, the apparatus comprising:
a) a means for acquiring real parts of application data;
b) a means for associating the real parts of the application data with a base grid having a number of sample points to form a digital representation of an analytical function having a discrete Fourier representation;
c) a means for calculating a circulant matrix representing a transformation of the real parts of the application data on the base grid to interpolate real and imaginary parts of the application data on an evaluation grid with a function that is analytical inside a unit circle, the evaluation grid having a center at zero, a radius that is inside a radius of convergence and an argument that is between zero and 2PI;
d) a means for transforming the real parts of the application data on the base grid with the circulant matrix, thereby obtaining real and imaginary parts of evaluation data on the evaluation grid; and
e) a means for writing the real and imaginary parts of the evaluation data on the evaluation grid to at least one of a display and a storage unit.
